(19) United States
(12) Patent Application Publication
(10) Pub. No.: US 2010/0277453 A1
(43) Pub. Date: Nov. 4, 2010

(54) METHOD OF DRIVING ELECTRONIC PAPER

(75) Inventors: Wen-Chun Wang, Taichung City (TW); Chih-Chang Lai, Taichung County (TW); Jyun-Sian Li, Tainan City (TW); Chien-Ting Chan, Changhua County (TW); Cheng-Yi Chou, Yunlin County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: WINTEK CORPORATION, Taichung (TW)

(21) Appl. No.: 12/497,701

(22) Filed: Jul. 6, 2009

(30) Foreign Application Priority Data
Apr. 30, 2009 (TW) 98114409

(51) Int. Cl. G09G 5/00

(52) U.S. Cl. 345/211

(57) ABSTRACT

A method of driving an electronic paper solving an image sticking problem is provided. First, a frame writing process is executed, wherein a turn-on voltage is supplied to scan lines to enable transistors, and a frame data voltage is supplied to display units through data lines to write a frame. Then, a frame holding process is executed, wherein a turn-off voltage and an auxiliary data voltage are respectively supplied to the scan lines and the data lines to disable the transistors, and a first common voltage is provided by a common electrode layer. During the frame holding process, the first common voltage and the frame data voltage are applied to hold the frame, the turn-off voltage, the auxiliary data voltage, and the first common voltage are fixed voltages, and the auxiliary data voltage is substantially equal to the first common voltage and greater than the turn-off voltage.

### CROSS-REFERENCE TO RELATED APPLICATION

This application claims the priority benefit of Taiwan application serial No. 98114409, filed on Apr. 30, 2009. The entirety of the above-mentioned patent application is hereby incorporated by reference herein and made a part of this specification.

### BACKGROUND OF THE INVENTION

1. Field of the Invention

The present invention generally relates to a driving method, and more particularly, to a method for resolving an image sticking problem of an electronic paper.

2. Description of Related Art

Some well-known electronic paper display techniques include electrophoretic display, liquid powder display, charged polymer particle display, cholesteric liquid crystal display, and electrowetting display, etc.

To be specific, an electronic paper includes a front plane laminate (FPL), a transistor array substrate, and a display array disposed between the FPL and the transistor array substrate, wherein the display array is composed of a plurality of microcapsules, and each of the microcapsules contains black liquid and white color charged particles. When the electric field between each pixel electrode of the transistor array substrate and a common electrode layer changes, the white color charged particles move upwards or downwards according to the direction of the electric field, so as to allow each pixel to present white or black color.

However, since the electric field changes along with the voltage difference between the pixel electrode in each display unit and the common electrode layer, the display quality of the electronic paper is related to the voltage holding ratio between the pixel electrode and the common electrode layer. Before a user looks at a frame, a frame data is input into the pixel electrodes in the display units through enabled transistors, so as to show an overall image due to the display units presented respectively according to the corresponding frame data. When the user looks at the frame, the transistors electrically connected to the pixel electrodes are disabled so that the frame can be constantly displayed until the user executes a frame erasing process so as to enter the next frame.

### SUMMARY OF THE INVENTION

Accordingly, the present invention is directed to a method of driving an electronic paper, wherein an image sticking problem in the electronic paper can be resolved.

The present invention is further directed to a method of driving an electronic paper, and this method allows the electronic paper to clearly display a frame for a long time.

The present invention provides a method of driving an electronic paper, wherein the electronic paper comprises a plurality of display units, a plurality of transistors for respectively controlling the display units, a common electrode layer, a plurality of scan lines and a plurality of data lines for driving the transistors. The driving method of driving an electronic paper in the present invention comprises following steps. First, a frame writing process is executed, wherein the frame writing process including the following steps. A turn-on voltage is supplied to the scan lines to enable the transistors, and a frame data voltage is supplied to the display units through the data lines to write a frame. Then, a frame holding process is executed, wherein the frame holding process including the following steps. A turn-off voltage is supplied to the scan lines and an auxiliary data voltage is supplied to the data lines, so as to disable the transistors, and a first common voltage is provided by the common electrode layer. In addition, during the frame holding process, the first common voltage and the frame data voltage are supplied to hold the frame, the turn-off voltage, the auxiliary data voltage, and the first common voltage are fixed voltages, and the auxiliary data voltage is substantially equal to the first common voltage and greater than the turn-off voltage.

According to an embodiment of the present invention, the difference between the turn-off voltage and the auxiliary data voltage is greater than or equal to 5V. According to an embodiment of the present invention, the turn-off voltage and the turn-on voltage have an equivalent value but opposite signs, and the auxiliary data voltage and the first common voltage are substantially 0V. According to an embodiment of the present invention, the turn-off voltage is substantially equal to −20V.

According to an embodiment of the present invention, after executing the frame holding process, the method further comprises executing a frame erasing process, wherein the turn-on voltage is supplied to the scan lines to enable the transistors, and a data erasing voltage is supplied to the display units through the data lines to erase the frame. According to an embodiment of the present invention, during the frame erasing process, a second common voltage is provided by the common electrode layer, and the data erasing voltage and the frame data voltage have opposite polarities corresponding to the second common voltage.

According to an embodiment of the present invention, the method of driving an electronic paper further comprises repeatedly executing the frame writing process, the frame holding process, and the frame erasing process.

According to an embodiment of the present invention, after executing the frame holding process, the method of driving an electronic paper further comprises executing a shutdown process, wherein shutdown process including the following steps. A shutdown scan voltage is supplied to the scan lines to enable the transistors, and a shutdown data voltage is supplied to the display units through the data lines to provide a shutdown frame, wherein a second common voltage is provided by the common electrode layer, and the shutdown data voltage is substantially equal to the second common voltage. According to an embodiment of the present invention, the shutdown data voltage and the second common voltage are grounded.

According to an embodiment of the present invention, before executing the frame writing process, the method of driving an electronic paper further comprises executing a wakeup process, wherein wakeup process comprises supplying a disturbing voltage difference to wake up a display array.

The present invention further provides a method of driving an electronic paper, wherein the electronic paper comprises a plurality of display units, a plurality of transistors for respectively controlling the display units, a common electrode layer, a plurality of scan lines for driving the transistors, and a plurality of data lines. The method of driving an electronic paper in the present invention comprises following steps. First, a shutdown process is executed, wherein a shutdown scan voltage is supplied to the scan lines to enable the transistors, and a shutdown data voltage is supplied to the display units through the data lines to provide a shutdown frame, and a common voltage is provided by the common electrode layer, and the shutdown data voltage is substantially equal to the common voltage.

According to an embodiment of the present invention, the shutdown data voltage and the common voltage are grounded.

According to an embodiment of the present invention, a short circuit is formed by the data lines and the common electrode layer.

According to an embodiment of the present invention, the shutdown process further comprises following steps. A shutdown signal is received before providing the shutdown frame. Besides, during a period of the timing before providing the shutdown frame to the timing after receiving the shutdown signal, a totally white frame or a totally black frame is written. According to an embodiment of the present invention, the shutdown process further comprises erasing a previous frame before writing the totally white frame or the totally black frame.

The method of driving an electronic paper provided by the present invention is suitable for driving different types of electronic papers, and which can effectively resolve the image sticking problem in any electronic paper and allow the electronic paper to clearly display a frame for a long time.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a partial circuit view of an electronic paper according to an embodiment of the present invention.

FIG. 2 is a partial cross-sectional view of an electronic paper according to an embodiment of the present invention.

FIG. 3 is a flowchart of an electronic paper driving method according to an embodiment of the present invention.

FIG. 4A is a diagram of an electronic paper during a frame holding process according to an embodiment of the present invention.

FIG. 4B is a diagram of an electronic paper during a frame holding process according to another embodiment of the present invention.

FIG. 4C is a diagram of an electronic paper during a frame holding process according to yet another embodiment of the present invention.

FIG. 5 and FIG. 6 are flowcharts of two different shutdown processes of an electronic paper according to an embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

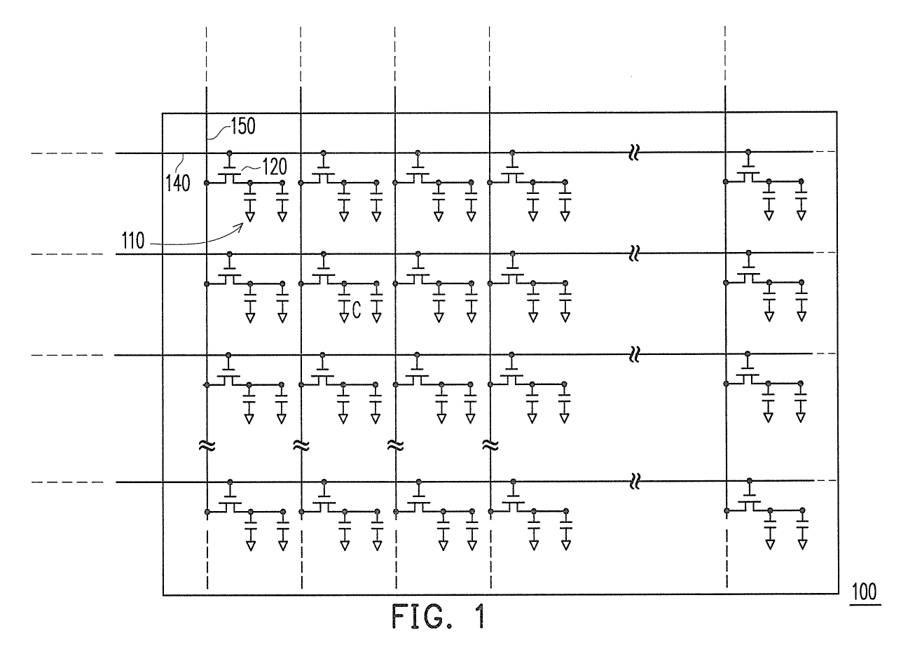

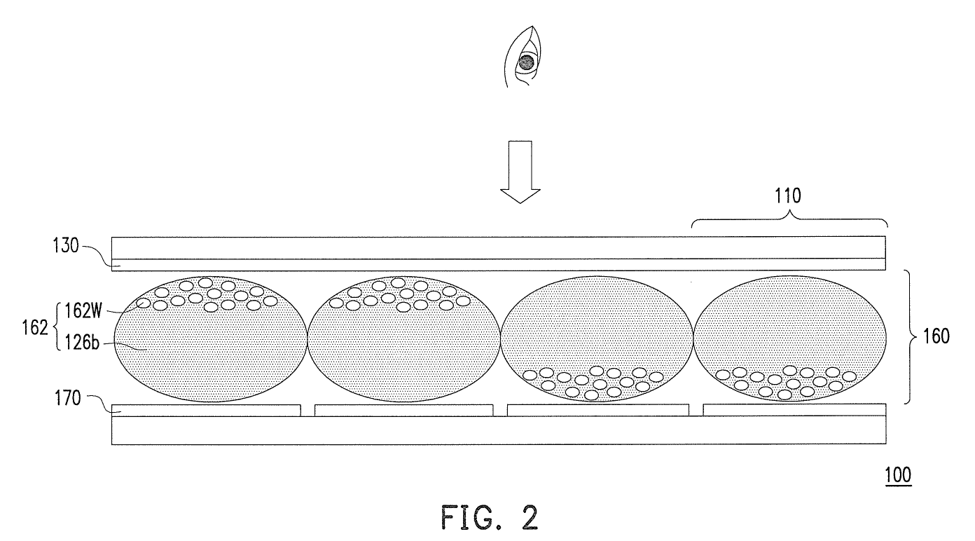

FIG. 1 is a partial circuit view of an electronic paper according to an embodiment of the present invention, and FIG. 2 is a partial cross-sectional view of an electronic paper according to an embodiment of the present invention. Referring to both FIG. 1 and FIG. 2, in the present embodiment, the electronic paper 100 includes a plurality of display units 110, a plurality of transistors 120 for respectively driving the display units 110, a common electrode layer 130, a plurality of scan lines 140, and a plurality of data lines 150, wherein the display units 110 may be arranged in an array, and each of the display units 110 is corresponding to a transistor 120, a scan lines 140, and a data lines 150.

As described above, in the present embodiment, a display array 160 composed of a plurality of microcapsules 162 is disposed in the electronic paper 100, wherein the microcapsules 162 are arranged as an array, and each of the microcapsules 162 includes a black liquid 162b and white color charged particles 162w. As shown in FIG. 2, the white color charged particles 162w is movable in the black liquid 162b, and the white color charged particles 162w can move forward to the top or the bottom of the microcapsule 162 according to the voltage difference between the corresponding pixel electrode 170 and the common electrode layer 130, wherein a corresponding data voltage is input into the pixel electrode 170 through the data line 150 electrically connected to the pixel electrode 170. In brief, the electronic paper 100 displays a frame according to the relative moving direction of the white color charged particles 162w.

Substantially, a wakeup process is further executed before the aforementioned frame writing process (to be described in detail below) is executed. This wakeup process is to position the white color charged particles 162w (which are currently randomly arranged) in the bottom of the microcapsules 162 before the frame writing process is executed for the first time. For example, in the present embodiment, during the wakeup process, a common voltage +V and a pixel voltage −V are respectively supplied to the common electrode layer 130 and the pixel electrode 170 for a sustained period, such as 0.5 second. Herein a disturbing voltage difference is formed between the common voltage +V and the pixel voltage −V such that the white color charged particles 162w are disturbed in the black liquid 162b. Next, a common voltage −V and a pixel voltage +V are respectively supplied to the common electrode layer 130 and the pixel electrode 170 for a sustained period, such as 0.5 second, so that the white color charged particles 162w are disturbed afresh due to the disturbing voltage difference between the common voltage −V and the pixel voltage +V. Accordingly, in the present embodiment, the display array 160 can be woken up by providing a disturbing voltage difference to the display array 160 for several times (about two or more times), so as to position the white color charged particles 162w at the bottom of the microcapsules 162.

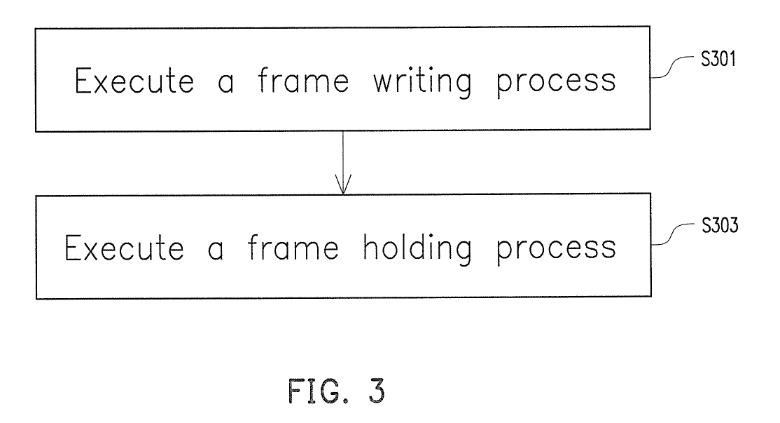

FIG. 3 is a flowchart of an electronic paper driving method according to an embodiment of the present invention. Referring to FIGS. 1˜3, the electronic paper driving method in the present embodiment includes following steps. First, in step S301, a frame writing process is executed. For example, during the frame writing process in the present embodiment, a turn-on voltage of 20V is supplied to the scan lines 140 to enable the transistors 120, and a frame data voltage of 15V is supplied to the display units 110 through the data lines 150. Accordingly, the 15V frame data voltage is transmitted to the pixel electrodes 170 corresponding to the data lines 150, and a voltage difference is formed between the pixel electrodes 170 and the common electrode layer 130 for controlling the white color charged particles 162w to move upwards from the bottom of the microcapsules 162. When the white color charged particles 162w reach the top of the microcapsules 162, each display unit 110 presents white color, and the operation of writing a frame is completed. However, foregoing voltage values are merely exemplified and not intended for limiting the present invention, and these voltage values can be determined by a user according to the actual requirement.

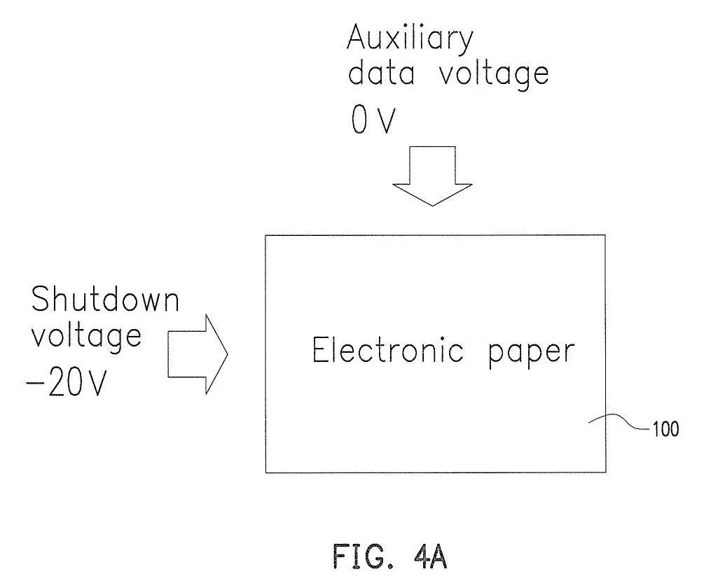

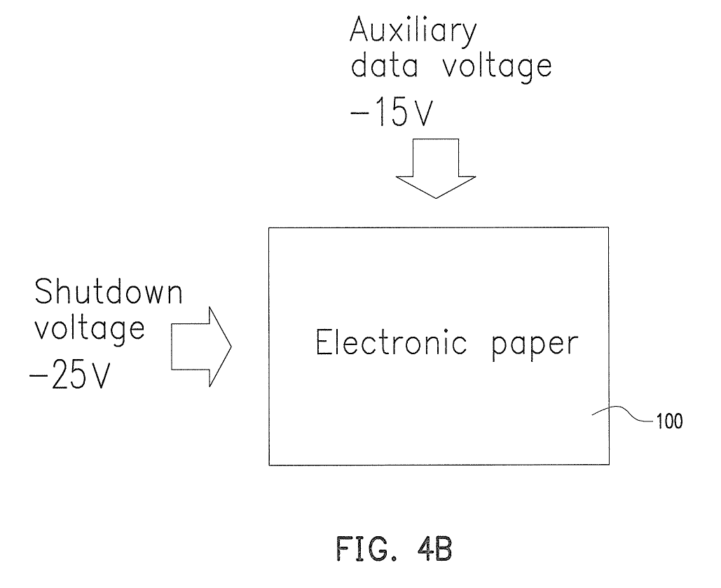

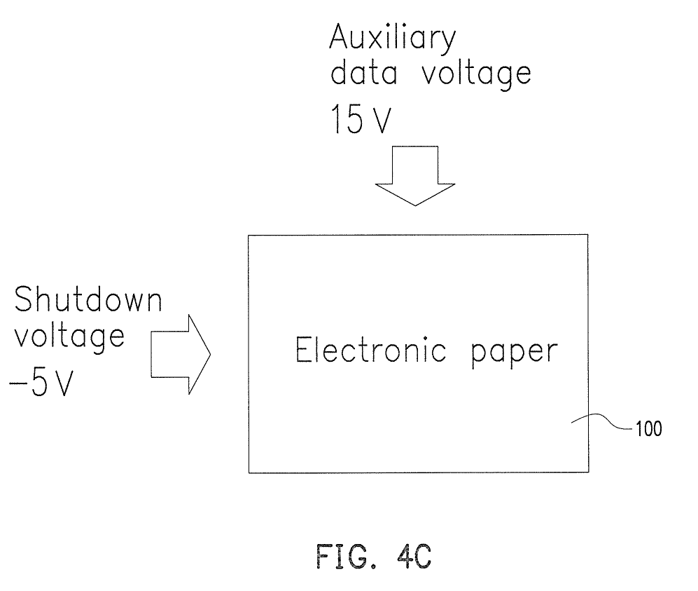

Thereafter, in step S303, a frame holding process is executed to hold the frame. For example, as shown in FIG. 4A, during the frame holding process in the present invention, a turn-off voltage having the same value but opposite sign as the turn-on voltage (i.e. −20V) is supplied to the scan lines 140 to disable the transistors 120, and an auxiliary data voltage of 0V is supplied to the data lines 150 to maintain the voltage holding ratio of the display units 110, so as to hold the frame for a longer time and resolving the image sticking problem in the electronic paper 100. In another embodiment of the present invention, a turn-off voltage of −25V and an auxiliary data voltage of −15V may also be respectively supplied to the scan lines 140 and the data lines 150, as shown in FIG. 4B. Or, as shown in FIG. 4C, a turn-off voltage of −5V and an auxiliary data voltage of 15V are respectively supplied to the scan lines 140 and the data lines 150. In addition, the turn-off voltage, the auxiliary data voltage, and the common voltage provided by the common electrode layer 130 are all fixed voltages such that the power consumed by the display array 160 during the frame holding process can be reduced, wherein the common voltage is substantially equal to the auxiliary data voltage and greater than the turn-off voltage.

It should be mentioned that the frame can be held for a long time when the difference between the turn-off voltage and the auxiliary data voltage is greater than or equal to 5V. In an exemplary embodiment of the present invention, when the auxiliary data voltage and the common voltage for executing the frame holding process are substantially 0V, the power consumption of the display array 160 during the frame holding process can be effectively reduced. However, foregoing voltage values are only used for describing the present invention but not for limiting the scope thereof.

As described above, during the frame holding process in the present embodiment, a frame displayed by the electronic paper 100 can be held for a longer time through the settings of the turn-off voltage and the auxiliary data voltage. However, the power consumption of the electronic paper 100 can be reduced by setting the turn-off voltage, the auxiliary data voltage, and the first common voltage to fixed values. In addition, foregoing voltage settings allow a frame displayed in the electronic paper 100 to be held for a longer time so that the image sticking problem in the electronic paper 100 can be resolved.

Next, a frame erasing process is further executed after the frame holding process is executed. The frame erasing process is executed to position the white color charged particles 162w to return to the bottom of the microcapsules 162 before next time the frame writing process is executed. For example, during the frame erasing process in the present embodiment, a turn-on voltage of 20V is supplied to the scan lines 140 to enable the transistors, and a data erasing voltage having the same value but opposite sign with the frame data voltage (i.e., −15V) is supplied to the display units 110 through the data lines 150. Accordingly, the data erasing voltage of −15V is transmitted to the pixel electrodes 170 corresponding to the data lines 150, and a voltage difference is formed between the pixel electrodes 170 and the common electrode layer 130 for controlling the white color charged particles 162w to move downwards or upwards. The operation of clearing the frame is completed when the white color charged particles 162w reach the bottom of the microcapsules 162. After that, the frame writing process, the frame holding process, and the frame erasing process are sequentially executed again to display a next frame.

It should be noted that the data erasing voltage (−15V) and the frame data voltage (15V) can have an equivalent value but opposite signs if the common voltage in the frame erasing process and the frame writing process is exactly 0V. In another embodiment of the present invention, if the common voltage provided by the common electrode layer 130 during the frame erasing process and the frame writing process is not 0V, the data erasing voltage and the frame data voltage should have opposite polarities corresponding to the second common voltage.

However, in an actual application, the electronic paper can be shut down by executing a shutdown process. To be specific, during the shutdown process in the present embodiment, a shutdown scan voltage is supplied to the scan lines to enable the transistors, and a shutdown data voltage is supplied to the display units through the data lines to provide a shutdown frame, wherein another common voltage substantially equal to the shutdown data voltage is provided by the common electrode layer. In an embodiment of the present invention, the shutdown data voltage and the common voltage having the same value may be obtained by forming a short circuit between the data lines and the common electrode layer. In another embodiment of the present invention, the shutdown data voltage and the common voltage having the same value may be obtained by grounding the data lines and the common electrode layer. It should be noted that such a shutdown process can help to resolve the image sticking problem when the electronic paper is shut down.

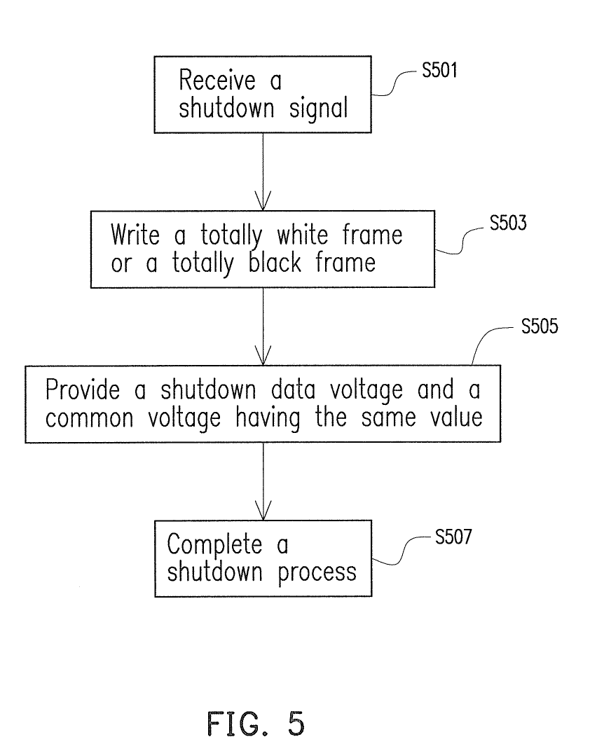

Additionally, the shutdown process may further include other steps. As shown in FIG. 5, first, in step S501, a shutdown signal is received. Then, in step S503, a totally white frame or a totally black frame is written. Next, in step S505, a shutdown data voltage and a common voltage having the same value are provided, and the implementation of this step has been described above therefore will not be described herein. After that, in step S507, the shutdown process is completed.

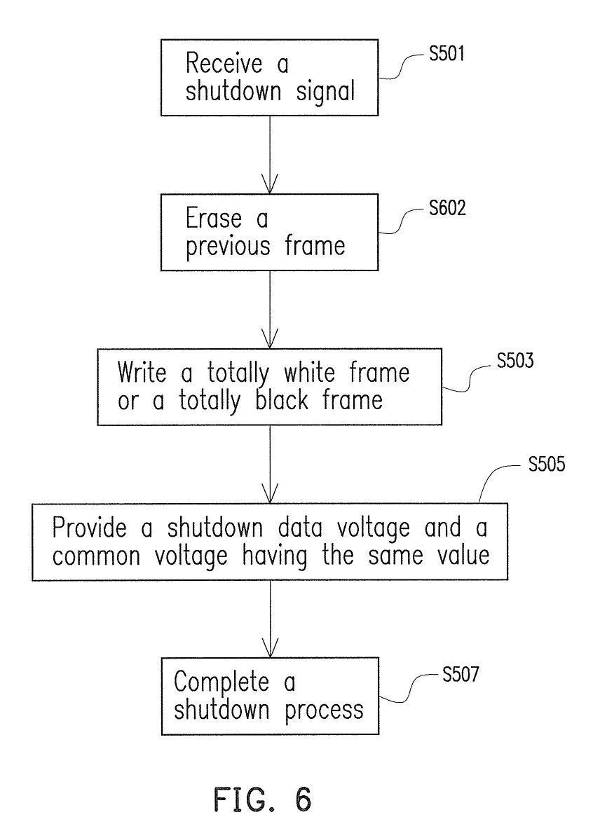

In another embodiment of the present invention, the shutdown process may further include the step S602 illustrated in FIG. 6, wherein a previous frame is erased before the totally white frame or the totally black frame is written. Particularly, this step can help to reduce the residual voltage in the electronic paper 100 close to 0 so that the image sticking problem when the electronic paper is shut down can be resolved.

It should be noted herein that the microcapsules 162 in the present embodiment are only used for describing the method of driving the display array 160 in the present embodiment but not for limiting the present invention. For example, the microcapsules may be composed of a transparent liquid, white color charged particles, and black color charged particles; or, the display array may be composed of a plurality of microcups, etc. In short, the electronic paper driving method in the present invention is suitable for different type of electronic paper 100, and the structure or type of the display array 160 is not limited in the present invention.

As described above, the present invention provides a method of driving an electronic paper, wherein a turn-off voltage and an auxiliary data voltage are set during a frame holding process to drive the transistors, and a shutdown data voltage and a common voltage having the same value are set during a shutdown process. Thereby, compared to the conventional technique, the driving method in the present invention can effectively resolve the image sticking problem in the electronic paper and allow the electronic paper to display an image clearly for a longer time.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method of driving an electronic paper, for resolving an image sticking problem in the electronic paper, wherein the electronic paper comprises a plurality of display units, a plurality of transistors respectively controlling the display units, a common electrode layer, a plurality of scan lines and a plurality of data lines for driving the transistors, the method of driving an electronic paper comprising:
executing a frame writing process, wherein the frame writing process comprises supplying a turn-on voltage to the scan lines to enable the transistors, and supplying a frame data voltage to the display units through the data lines to write a frame; and
executing a frame holding process, wherein the frame holding process comprises supplying a turn-off voltage to the scan lines and supplying an auxiliary data voltage to the data lines to disable the transistors, a first common voltage is provided by the common electrode layer, the first common voltage and the frame data voltage are supplied to hold the frame, the turn-off voltage, the auxiliary data voltage, and the first common voltage are fixed voltages, and the auxiliary data voltage is substantially equal to the first common voltage and greater than the turn-off voltage.

2. The method of driving an electronic paper according to claim 1, wherein a voltage difference between the turn-off voltage and the auxiliary data voltage is greater than or equal to 5V.

3. The method of driving an electronic paper according to claim 2, wherein the turn-off voltage and the turn-on voltage have an equivalent value but opposite signs, and the auxiliary data voltage and the first common voltage are substantially equal to 0V.

4. The method of driving an electronic paper according to claim 3, wherein the turn-off voltage is substantially equal to −20V.

5. The method of driving an electronic paper according to claim 1, wherein after executing the frame holding process, the method of driving an electronic paper further comprises:
executing a frame erasing process, wherein the erasing process comprises supplying the turn-on voltage to the scan lines to enable the transistors, and supplying a data erasing voltage to the display units through the data lines to erase the frame.

6. The method of driving an electronic paper according to claim 5, wherein during the frame erasing process, a second common voltage is provided by the common electrode layer, and the data erasing voltage and the frame data voltage have opposite polarities according to the second common voltage.

7. The method of driving an electronic paper according to claim 5, further comprising repeatedly executing the frame writing process, the frame holding process, and the frame erasing process.

8. The method of driving an electronic paper according to claim 1, wherein after executing the frame holding process, the method of driving an electronic paper further comprises:
executing a shutdown process, wherein shutdown process comprises supplying a shutdown scan voltage to the scan lines to enable the transistors, and supplying a shutdown data voltage to the display units through the data lines to provide a shutdown frame, a second common voltage is provided by the common electrode layer, and the shutdown data voltage is substantially equal to the second common voltage.

9. The method of driving an electronic paper according to claim 8, wherein the shutdown data voltage and the second common voltage are grounded.

10. The method of driving an electronic paper according to claim 1, wherein before executing the frame writing process, the method of driving an electronic paper further comprises:
executing a wakeup process, wherein the wakeup process comprises supplying a disturbing voltage difference to wake up a display array.

11. A method of driving an electronic paper, for resolving an image sticking problem in the electronic paper, wherein the electronic paper comprises a plurality of display units, a plurality of transistors respectively controlling the display units, a common electrode layer, a plurality of scan lines and a plurality of data lines for driving the transistors, the method of driving an electronic paper comprising:
executing a shutdown process, wherein the shutdown process comprises supplying a shutdown scan voltage to the scan lines to enable the transistors, and supplying a shutdown data voltage to the display units through the data lines to provide a shutdown frame, a common voltage is provided by the common electrode layer, and the shutdown data voltage is substantially equal to the common voltage.

12. The method of driving an electronic paper according to claim 11, wherein the shutdown data voltage and the common voltage are grounded.

13. The method of driving an electronic paper according to claim 11, wherein a short circuit is formed by the data lines and the common electrode layer.

14. The method of driving an electronic paper according to claim 11, wherein the shutdown process further comprises:
receiving a shutdown signal before providing the shutdown frame; and
writing a totally white frame or a totally black frame before providing the shutdown frame and after receiving the shutdown signal.

15. The method of driving an electronic paper according to claim 14, wherein the shutdown process further comprises:
erasing a previous frame before writing the totally white frame or the totally black frame.
